(19) United States
(12) Patent Application Publication
(10) Pub. No.: US 2010/0293032 A1
(43) Pub. Date: Nov. 18, 2010

(54) SYSTEM AND METHOD FOR SHARING COMMERCIAL INFORMATION

(75) Inventors: Johnathan R. Engelsma, Hudsonville, MI (US); Pallavi J. Kaushik, Chicago, IL (US); Tzvetan T. Horozov, Hoffman Estates, IL (US); Jehan Wickramasuriya, St. Charles, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/464,168

(22) Filed: May 12, 2009

(51) Int. Cl. G06Q 30/00; G06F 15/16; G06Q 10/00

(52) U.S. Cl. 705/10; 705/26; 709/206; 705/21; 705/27

(57) ABSTRACT

Disclosed is commercial-information sharing system in which a vendor provides a shopping device to a customer. When the shopping device presents commercial information to the customer that the customer finds interesting, the customer may choose to share the commercial information. The information is sent from the vendor's shopping device to a personal communications device of the customer. The customer then uses his personal communications device to share the information. The vendor may send tracking information along with the commercial information. If someone is interested in the commercial information shared by the original customer and goes to the vendor to, for example, redeem a coupon, the tracking information provides the vendor with important marketing data. The original customer may also share content that he generates and then associates with the commercial information.

### FIELD OF THE INVENTION

The present invention is related generally to personal communications devices and, more particularly, to using such devices to share commercial information.

### BACKGROUND OF THE INVENTION

As compared with traditional (“bricks and mortar”) shopping venues, on-line shopping presents several advantages to customers such as convenience, range of selection beyond what any traditional venue could reasonably provide, and easy price comparison among vendors. On-line vendors, too, reap several advantages including especially the opportunity to gather marketing data about their actual and potential customers such as product-viewing history, purchasing history, customer preferences, and demographics. Customers and vendors both benefit from newer social-network tools that allow a customer to bookmark and share information about preferred products (and services) with the customer's friends and family. The sharing of this information exposes the vendor's offerings to a larger community of potential customers which may result in increased sales and an increased gathering of marketing data. To encourage customers to share product information, a vendor may track the proliferation of product information and then reward loyal customers when their referrals result in increased sales to the vendor.

Attempting to compete with the on-line vendors, traditional vendors are beginning to apply some of these same techniques. When entering a retail outlet, a customer may be given a “shopping device” (e.g., a Motorola MC17). The shopping device provides retail customers with features, such as product bar-code scanning, that enhance the shopping experience. Some shopping devices also provide expanded product information when queried, suggest that the customer may wish to purchase additional products related to the products already in the customer's shopping cart, and alert the customer to special sales offers. At the same time, the shopping device identifies the customer to the vendor, tracks the customer's purchasing patterns, updates the vendor's inventory, and gathers marketing data. The traditional vendor can implement a loyalty program based on this gathered data.

### BRIEF SUMMARY

The above considerations, and others, are addressed by the present invention, which can be understood by referring to the specification, drawings, and claims. According to aspects of the present invention, a vendor provides a shopping device to a customer. When the shopping device presents commercial information to the customer that the customer finds interesting (e.g., a special-price offer for a product that the customer wants), the customer may choose to share the commercial information. The information is sent from the vendor's shopping device to a personal communications device (e.g., a cellular telephone or personal digital assistant) of the customer. The customer then uses his personal communications device to share the information.

The customer may send the commercial information to any of a number of “socialization media.” For example, the customer may e-mail the information to a friend or post it on-line. In some embodiments, the customer's personal communications device analyzes the commercial information, compares it against information that the customer has stored about certain of his contacts (e.g., Bob and Marie have a very young child or Isaac raises horses), and then chooses appropriate contacts with whom to share this particular piece of commercial information. Specifics about the contacts and about the socialization medium chosen by the customer remain on the customer's personal communications device and need not be shared with the vendor, thus providing a high level of privacy protection.

In some embodiments, the vendor sends tracking information along with the commercial information. If someone is interested in the commercial information shared by the original customer and goes to the vendor to, for example, redeem a coupon, the tracking information provides the vendor with important marketing data. The vendor may use that data to reward the customer who originally shared the commercial information.

In some embodiments, the original customer may also share content that he generates and then associates with the commercial information. For example, the customer may send his own rating of a product or provide hints on how to better use it.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIG. 2 is a flowchart of an exemplary method for sharing commercial information;

FIG. 3 is a flowchart of an exemplary method for using shared commercial information; and

FIGS. 4a and 4b are schematics of an exemplary personal communications device usable with the present invention.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

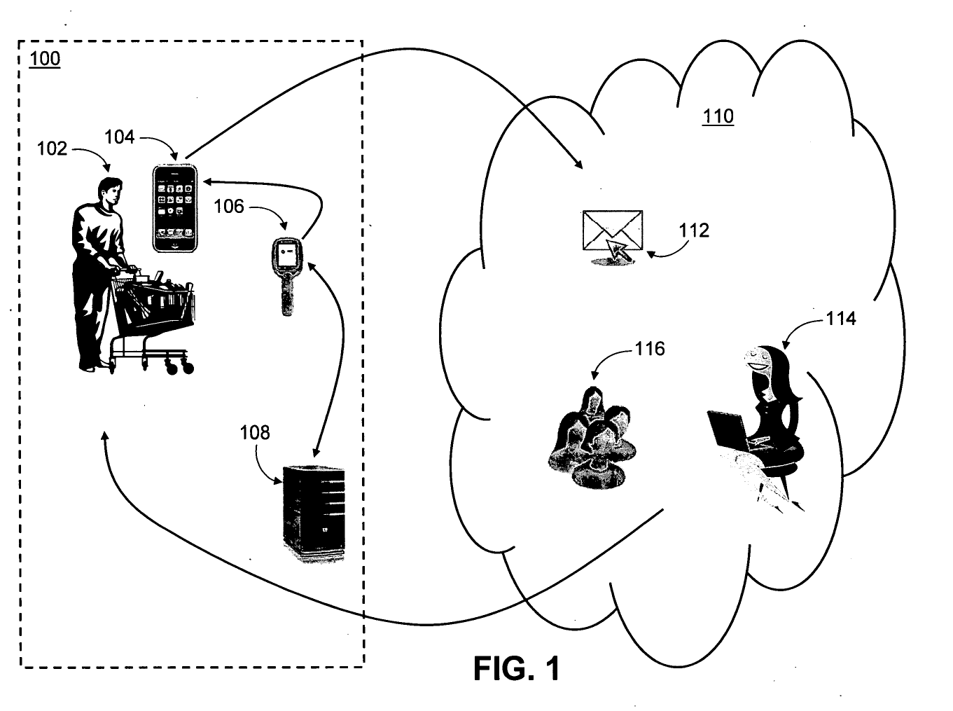

In FIG. 1, a person 102 visits a shopping venue 100 such as a retail store. The shopper 102 carries a personal communications device 104 (e.g., a cellular telephone, personal digital assistant, or portable computer). The vendor of the store 100 provides the shopper 102 with access to a shopping device 106. Various types of shopping devices 106 are available, providing various functions. Some devices 106 are carried by the shopper 102 while in the store 100. The shopper 102 uses the device 106 to, for example, scan bar codes of interesting products and pull up product and pricing information or special offers. The shopper 102 may use the shopping device 106 to identify himself to the vendor of the store 100 (e.g., by scanning a customer loyalty card) and may thus receive targeted advertising or “preferred customer” discounts. In some stores 100, the shopper 102 uses the device 106 to scan and record the products that he is purchasing. The device 106 can then provide the shopper 102 with a running tally of purchases made and can facilitate the purchase transaction at the end of the shopper's visit.

While the shopping device 106 is illustrated in FIG. 1 as a portable device carried by the shopper 102, other shopping devices 106 are contemplated. A shopping device 106 can be a kiosk that provides product information and advertising. Another type of shopping device 106 consists of the product scanner and associated equipment in a self-checkout lane.

Some stores 100 include a server 108. (The physical location of the server 108 is not important to the present discussion.) The server 108 communicates with the shopping device 106 to, for example, provide the device 106 with up-to-date product and pricing information and to update the vendor's inventory as products are purchased. If the shopper 102 identifies himself to the vendor, then the server 108 can send targeted information to the shopper 102 and can accumulate specific marketing information (e.g., how often this particular shopper 102 comes into the store 100 and how much and what he usually buys).

In some situations, the shopper 102 may wish to share commercial information gathered during his shopping trip. As one example, he may be impressed with the selection of products available in the store 100 or in their prices. In another example, he may wish a friend of his to review product information in order to vet a potential purchase. According to some aspects of the present invention, information provided by the shopping device 106 is transferred to the personal communications device 104 of the shopper 102. (The information may also be transferred directly from the server 108 to the personal communications device 104.) The shopper 102 then uses the communications capabilities of his personal communications device 104 to share this information. In FIG. 1, the information to be shared in sent via a communications network 110 to one or more “socialization media.” For example, the shopper 102 pulls up a list of contacts on his personal communications device 104 and sends an e-mail 112 containing the information to be shared to his friend 114. This friend 114 receives the e-mail 112 and reads the information shared by the shopper 102. When the information includes an attractive pricing offer for a product of interest to the friend 114, she may decide to act on the offer by visiting the store 100 and purchasing the product. In another example, the shopper 102 shares the information by posting it to a social-networking site 116. The posting may induce some readers to visit the store 100.

Because the shopper 102 uses his own personal communications device 104 to share the commercial information, the shopper 102 does not divulge his contact lists or other personal information to the vendor of the store 100. Also, the shopper 102 does not need to learn how to use a new device to share this information. The vendor of the store 100 benefits from increased traffic generated by the shopper's sharing of the information with his friends. To encourage information sharing, the vendor may reward the shopper 102 whenever the shopper's sharing generates a sale.

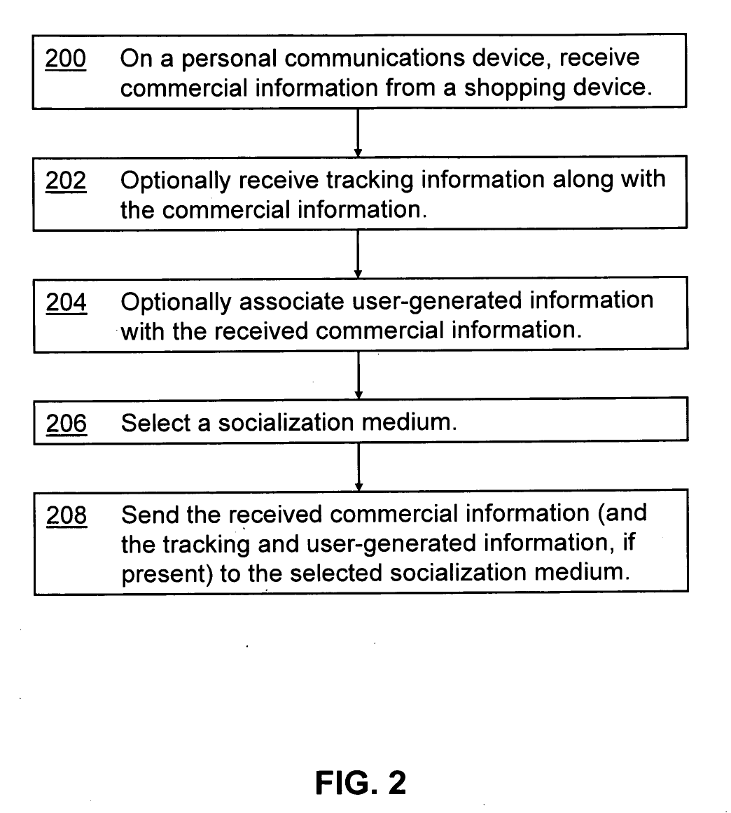

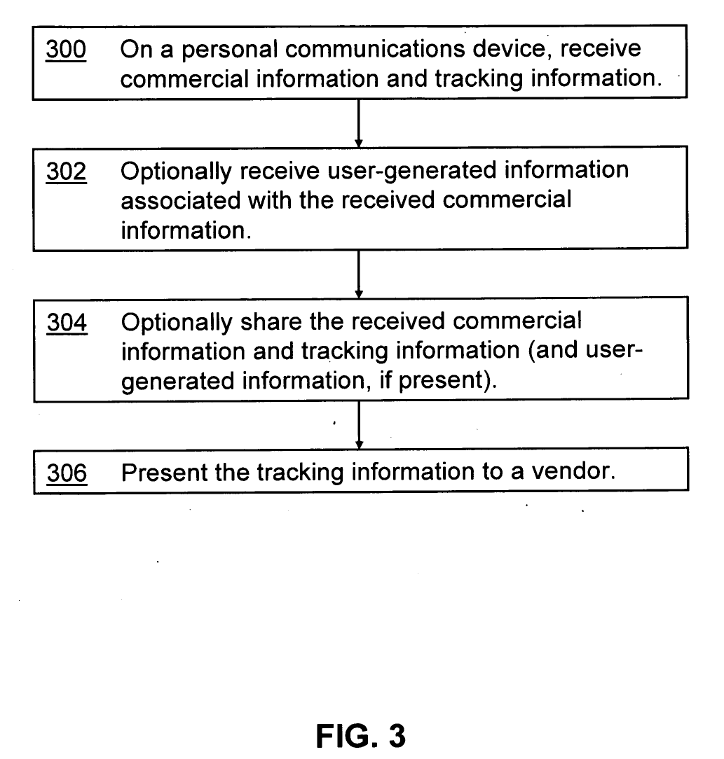

More examples and details are presented with reference to the flowcharts of FIGS. 2 and 3. FIG. 2 presents an exemplary method for sharing commercial information. The method begins with step 200 where the personal communications device 104 of the shopper 102 receives some commercial information directly from a shopping device 106 (or indirectly via the sever 108). Note that while in some embodiments, this step 200 requires an explicit action by the shopper 102, in other embodiments, the personal communications device 104 can be configured to automatically receive this information (e.g., whenever a product is scanned by the shopping device 106, commercial information about that product is sent to the personal communications device 104). In one embodiment, the communications link between the shopping device 106 and the personal communications device 104 is carried by short-range radio (e.g., Bluetooth); other possibilities are considered including infrared. In a preferred embodiment, the shopping device 106 sends a “share” message to the vendor's server 108. The server 108 then sends the commercial information to the personal communications device 104 via, for example, a WAN or an SMS message.

In optional step 202, the personal communications device 104 also receives tracking information associated with the received commercial information. This information may encode the date that the commercial information was generated and may include an identification of the shopper 102. Usually, the tracking information is used by the vendor of the store 100 to evaluate information-distribution channels and to associate the commercial information with the particular shopper 102. The use of this tracking information is discussed below in relation to step 306 of FIG. 3.

The shopper 102 may choose to generate his own information and, in optional step 204, associate it with the received commercial information. For example, the shopper 102 can include a review of the associated product or a simple message saying why he cares to share this information. In more elaborate scenarios, the shopper 102 can include a photograph or video (e.g., of the new puppy he just bought) or his views on how to better use the product.

In step 206, a “socialization medium” is chosen. Some possible media are discussed above in relation to FIG. 1: sending an e-mail 112 or posting to a social-networking website 116. Other possible socialization media include SMS messaging or on-line presence services. In general, different media may be appropriate for different products depending upon, for example, the audience expected to be interested in the information and how long the information will be relevant. A person newly engaged can post product information to a wedding registry “wish list” that will remain relevant at least until the wedding, while information about a sale on organic strawberries may only be relevant for a few hours.

In the example of FIG. 1, the shopper 102 explicitly chooses the socialization media. Another possibility is that the personal communications device 104 will interpret the received commercial information, review information about contacts (stored either on the device 104 itself or remotely accessible), choose which contacts may be interested in the information, and then choose the appropriate socialization media to reach those contacts. As a simple example, a sale on baby products may induce the personal communications device 104 to share the sale information with those contacts known to have very young children.

Then in step 208, the commercial information is sent to the selected socialization media. Tracking information and user-generated content, if available, are also sent. Note that there is no requirement that this sending happens while the shopper 102 is still at the store 100. The personal communications device 104 can store the commercial information until, for example, the shopper 102 brings the product home, tries it, writes a review or captures a short video relevant to the product, and then decides where to send it. Note also that all aspects of sending need not occur at one time. In particular, the shopper 102 may choose to add user-generated content to commercial information that he has already shared. In many embodiments, the tracking information is not seen by the shopper 102 and is automatically sent whenever the commercial information itself is shared.

FIG. 3 presents an exemplary method usable by a recipient of the shared commercial information. Using an example from the discussion of FIG. 1, the friend 114 receives an e-mail 112 containing the commercial information shared by the shopper 102 (step 300 of FIG. 3). Along with the shared commercial information, the friend 114 may also receive any tracking information provided by the vendor of the store 100 and any additional information generated by the shopper 102 (step 302). The friend 114 may choose to further share this information (step 304) using techniques similar to those discussed above in relation to the shopper 102 (compare steps 202, 204, 206, and 208 of FIG. 2). The friend 114 can even add her own user-generated content.

In step 306, the friend 114 (or any recipient of the shared commercial information) decides to act on the information by visiting the store 100. For example, the shared information can include a special-price offer, and the friend 114 visits the store 100 to take advantage of the offer. If the vendor included tracking information along with the original commercial information, then the receipt of this tracking information when the friend 114 visits the store 100 provides valuable marketing information to that vendor. The vendor may choose to reward the original shopper 102 for bringing his friend 114 into the store 100. The more visits generated by the sharing of the shopper 102, the more valuable the reward. Note that the “visit” of the friend 114 need not be a physical visit to the store 100: The vendor of the store 100 may also support a presence on the web, and the friend 114 may choose to redeem the commercial information via a web transaction.

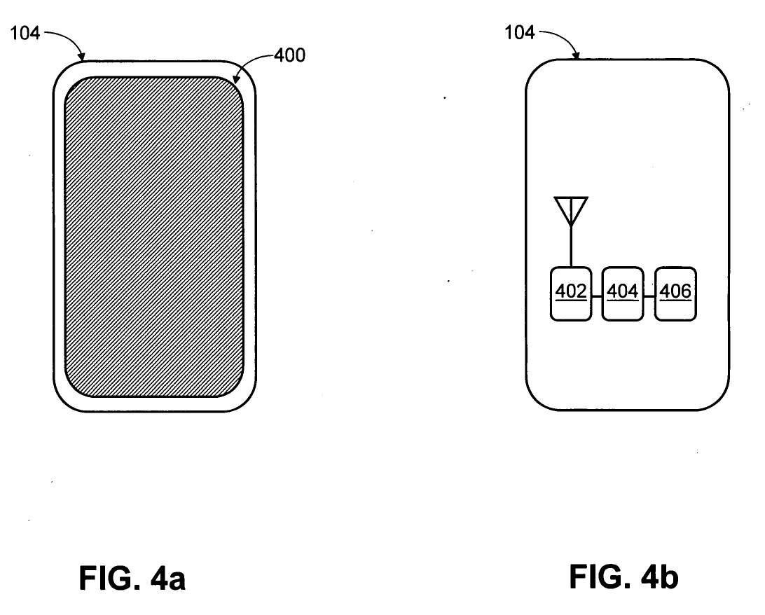

FIGS. 4a and 4b show a personal communications device 104 (e.g., a cellular telephone, personal digital assistant, or personal computer) that incorporates an embodiment of the present invention. FIGS. 4a and 4b show the device 104 as a cellular telephone presenting a touch-screen interface 400 to the shopper 102. The received commercial information can be displayed on the screen 400, and the shopper 102 can use the screen 400 to access a list of contacts with whom he will share the commercial information.

FIG. 4b illustrates some of the more important internal components of the personal communications device 104. The device 104 includes at least one communications transceiver 402, a processor 404, and a memory 406 for storing, among other things, a list of contacts.

In view of the many possible embodiments to which the principles of the present invention may be applied, it should be recognized that the embodiments described herein with respect to the drawing figures are meant to be illustrative only and should not be taken as limiting the scope of the invention. For example, any combination of short-range and long-range communications capabilities are contemplated for use by the personal communications device 104. Therefore, the invention as described herein contemplates all such embodiments as may come within the scope of the following claims and equivalents thereof.

We claim:

1. A method on a personal communications device for sharing commercial information, the method comprising:
receiving commercial information from a shopping device;
selecting a socialization medium; and
sending the received commercial information to the selected socialization medium.

2. The method of claim 1 wherein the personal communications device is selected from the group consisting of: a mobile telephone, a personal digital assistant, and a personal computer.

3. The method of claim 1 wherein the received commercial information is selected from the group consisting of: an advertisement, a price offer, a product review, and a pointer to product information.

4. The method of claim 1 wherein the shopping device is selected from the group consisting of: a portable shopping device, a kiosk, and a point-of-sale terminal.

5. The method of claim 1 wherein the socialization medium is selected from the group consisting of: an e-mail address, an SMS address, a social network, an on-line message board, an on-line presence service, and an on-line wish list.

6. The method of claim 1 wherein selecting a socialization medium comprises an element selected from the group consisting of: receiving selection information from a user of the personal communications device and analyzing the received commercial information.

7. The method of claim 1 further comprising:
sending user-generated information to the selected socialization medium.

8. The method of claim 7 wherein the user-generated information is selected from the group consisting of: an opinion, a review, an annotation, a photograph, and a video.

9. The method of claim 1 further comprising:
receiving tracking information from the shopping device; and
sending the tracking information to the selected socialization medium.

10. A personal communications device configured for sharing commercial information, the personal communications device comprising:
a transmitter; and
a processor operatively coupled to the transmitter, the processor configured for:
receiving, via the transmitter, commercial information from a shopping device;
selecting a socialization medium; and
sending, via the transmitter, the received commercial information to the selected socialization medium.

11. The personal communications device of claim 10 wherein the personal communications device is selected from the group consisting of: a mobile telephone, a personal digital assistant, and a personal computer.

12. The personal communications device of claim 10 wherein the processor is further configured for:
sending, via the transmitter, user-generated information to the selected socialization medium.

13. The personal communications device of claim 10 wherein the processor is further configured for:
receiving, via the transmitter, tracking information from the shopping device; and
sending, via the transmitter, the tracking information to the selected socialization medium.

14. The personal communications device of claim 10 further comprising:
a user interface operatively coupled to the processor;
wherein the processor is further configured for receiving, via the user interface, selection information from a user of the personal communications device.

15. A method on a first personal communications device for sharing commercial information, the method comprising:
receiving commercial information from a second personal communications device, the second personal communications device distinct from the first personal communications device;
receiving tracking information from the second personal communications device; and
presenting the tracking information to a vendor.

16. The method of claim 15 further comprising:
receiving user-generated information from the second personal communications device.

17. The method of claim 15 further comprising:
selecting a socialization medium; and
sending the received commercial information and the received tracking information to the selected socialization medium.

18. A first personal communications device configured for sharing commercial information, the first personal communications device comprising:
a transmitter; and
a processor operatively coupled to the transmitter, the processor configured for:
receiving, via the transmitter, commercial information from a second personal communications device, the second personal communications device distinct from the first personal communications device;
receiving, via the transmitter, tracking information from the second personal communications device; and
presenting the tracking information to a vendor.

19. The first personal communications device of claim 18 wherein the first personal communications device is selected from the group consisting of: a mobile telephone, a personal digital assistant, and a personal computer.

20. The first personal communications device of claim 18 wherein the processor is further configured for:
receiving, via the transmitter, user-generated information from the second personal communications device.

21. The first personal communications device of claim 18 wherein the processor is further configured for:
selecting a socialization medium; and
sending the received commercial information and the received tracking information to the selected socialization medium.

22. The first personal communications device of claim 21 further comprising:
a user interface operatively coupled to the processor;
wherein the processor is further configured for receiving, via the user interface, selection information from a user of the first personal communications device.
